(19) United States
(12) Patent Application Publication
(10) Pub. No.: US 2026/0245871 A1
(43) Pub. Date: Aug. 20, 2026

(54) POSITIVE ELECTRODE FOR LITHIUM-ION SECONDARY BATTERY AND LITHIUM-ION SECONDARY BATTERY

(71) Applicant: TOYOTA JIDOSHA KABUSHIKI KAISHA, Toyota-shi (JP)

(72) Inventor: Yuusuke SHIMIZU, Chiryu-shi (JP)

(73) Assignee: TOYOTA JIDOSHA KABUSHIKI KAISHA, Toyota-shi (JP)

(21) Appl. No.: 19/416,313

(22) Filed: Dec. 11, 2025

(30) Foreign Application Priority Data
Feb. 14, 2025 (JP) 2025-022225

(51) Int. Cl. H01M 4/36; H01M 4/02; H01M 4/131; H01M 4/136; H01M 4/505; H01M 4/525; H01M 4/58; H01M 10/0525

(52) U.S. Cl. CPC H01M 4/366; H01M 4/131; H01M 4/136; H01M 4/364; H01M 4/505; H01M 4/525; H01M 4/5825; H01M 2004/021; H01M 2004/028; H01M 10/0525

(57) ABSTRACT

A positive electrode including: a positive electrode mixture layer containing a layered rock salt oxide and an olivine compound as a positive electrode active material, in which the positive electrode mixture layer includes a first region proximate to a first surface facing a current collector in a thickness direction of the positive electrode mixture layer, a second region proximate to a second surface facing a separator in the thickness direction, and a third region that is a region between the first region and the second region in the thickness direction, and the first region and the second region contain the layered rock salt oxide at a higher concentration than the third region.

### CROSS-REFERENCE TO RELATED APPLICATION

This application claims priority to Japanese Patent Application No. 2025-022225 filed on Feb. 14, 2025. The disclosure of the above-identified application, including the specification, drawings, and claims, is incorporated by reference herein in its entirety.

### BACKGROUND

### 1. Technical Field

A technology disclosed in the present specification relates to a positive electrode for a lithium-ion secondary battery and a lithium-ion secondary battery.

### 2. Description of Related Art

A positive electrode active material that is a metal oxide containing lithium ions is commonly used in a positive electrode of a lithium-ion secondary battery. For example, a layered rock salt oxide and an olivine compound are used.

For example, in WO 20/261879, a lithium manganese iron phosphate (LMFP) that is an olivine compound and a nickel cobalt manganese composite oxide (NCM) that is a layered rock salt compound are combined as the positive electrode active material at a predetermined mass ratio. It is disclosed that this makes it possible to provide a positive electrode having high energy density and superior safety.

### SUMMARY

Meanwhile, it has been found that the positive electrode of WO 20/261879 has a problem of low electronic conductivity.

The present specification provides a positive electrode for a lithium-ion secondary battery and a lithium-ion secondary battery that have excellent electronic conductivity and reduce internal resistance of the battery.

According to the present specification, the following aspects are provided.

[1]A positive electrode including
a positive electrode mixture layer containing a layered rock salt oxide and an olivine compound as a positive electrode active material, in which
the positive electrode mixture layer includes a first region proximate to a first surface facing a current collector in a thickness direction of the positive electrode mixture layer, a second region proximate to a second surface facing a separator in the thickness direction, and a third region that is a region between the first region and the second region in the thickness direction, and
the first region and the second region contain the layered rock salt oxide at a higher concentration than the third region.

[2] The positive electrode according to [1],
in which a first particle size ratio that is a ratio of D₅₀ (volume basis) of the layered rock salt oxide to D₅₀ (volume basis) of the olivine compound in the first region is greater than a second particle size ratio that is a ratio of D₅₀ (volume basis) of the layered rock salt oxide to D₅₀ (volume basis) of the olivine compound in the second region.

[3] The positive electrode according to [1] or [2],
in which the first region is a region of 10% or less of a thickness of the positive electrode mixture layer from the first surface, and the second region is a region of 10% or less of a thickness of the positive electrode mixture layer from the second surface.

[4] The positive electrode according to any one of [1] to [3],
in which the third region includes a fourth region containing solely the olivine compound as the positive electrode active material.

[5]A lithium-ion secondary battery including:
the positive electrode according to any one of [1] to [4], the positive electrode being provided for the lithium-ion secondary battery;
a negative electrode; and
the separator.

With the positive electrode, the positive electrode mixture layer contains the layered rock salt oxide having excellent electronic conductivity at a higher concentration in the first region and the second region than in the third region. Therefore, the positive electrode mixture layer can exhibit excellent direct current internal resistance (DCIR). In addition, with the lithium-ion secondary battery including the positive electrode, the lithium-ion secondary battery exhibits excellent discharge characteristics (for example, a 3 C discharge rate). Further, by containing the layered rock salt oxide at a high concentration in the first region and the second region, it may be possible to contribute to an improvement in peel strength between the current collector and the separator and the positive electrode. Therefore, the secondary battery having excellent integrity of the positive electrode is provided.

In addition, the present specification provides the lithium-ion secondary battery including the positive electrode, the negative electrode, and the separator. With the lithium-ion secondary battery, the positive electrode that contributes to excellent cycle characteristics is provided, and thus the lithium-ion secondary battery having excellent cycle characteristics is provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a cell of a lithium-ion secondary battery;

FIG. 2 is a diagram schematically showing an example of a positive electrode mixture layer of the lithium-ion secondary battery; and

FIG. 3 is a diagram schematically showing an example of a manufacturing step of the positive electrode.

### DETAILED DESCRIPTION OF EMBODIMENTS

The present specification relates to a positive electrode for a lithium-ion secondary battery (hereinafter, also simply referred to as a secondary battery) and a secondary battery.

Hereinafter, the positive electrode and the secondary battery of the secondary battery disclosed in the present specification will be described with reference to the drawings as appropriate. In the present specification, the term “secondary battery” refers to a battery that can be repeatedly charged and discharged by movement of a charge carrier between a positive electrode and a negative electrode. In addition, in the present specification, the term “lithium-ion secondary battery” refers to a secondary battery in which lithium ions are used as charge carriers and charging and discharging are realized by movement of charges due to lithium ions between positive and negative electrodes. In addition, the secondary battery includes a positive electrode terminal and a negative electrode terminal with respect to an electrode body, and is usually accommodated in a battery case. The secondary battery may include a liquid or gel electrolyte as an electrolyte, or may be an all-solid-state secondary battery including a solid electrolyte. In addition, a shape of the secondary battery is not particularly limited.

### Positive Electrode for Secondary Battery

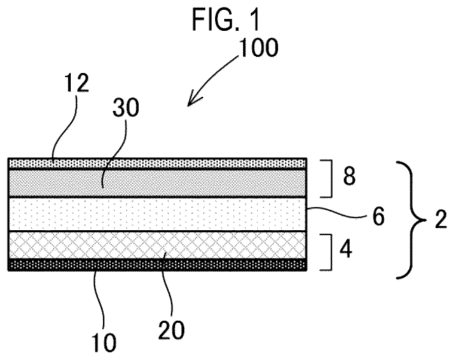

FIG. 1 schematically shows an example of a cell 2 of a secondary battery 100. As shown in FIG. 1, the cell 2 as a unit structure of the secondary battery 100 includes a positive electrode 4, a separator 6, and a negative electrode 8. The cell 2 further includes a positive electrode current collector 10 and a negative electrode current collector 12. The secondary battery 100 usually has a structure in which a large number of cells 2 are laminated. The separator 6 may hold, for example, a liquid or gel electrolyte.

### Positive Electrode Mixture Layer

The positive electrode 4 includes a positive electrode mixture layer 20. In the cell 2, the positive electrode current collector 10 is provided on one surface of the positive electrode mixture layer 20, and the separator 6 is provided on the other surface. The so-called positive electrode 4 may include the positive electrode mixture layer 20 alone or may include the positive electrode mixture layer 20 and the positive electrode current collector 10.

The positive electrode mixture layer 20 includes a positive electrode mixture. The positive electrode mixture contains a positive electrode active material. As the positive electrode active material, an olivine compound and a layered rock salt oxide can be used.

Next, a distribution of the layered rock salt oxide and the olivine compound in the positive electrode mixture layer 20 will be described. The positive electrode mixture layer 20 has a specific distribution with respect to the layered rock salt oxide and the olivine compound in a thickness direction of the positive electrode mixture layer 20.

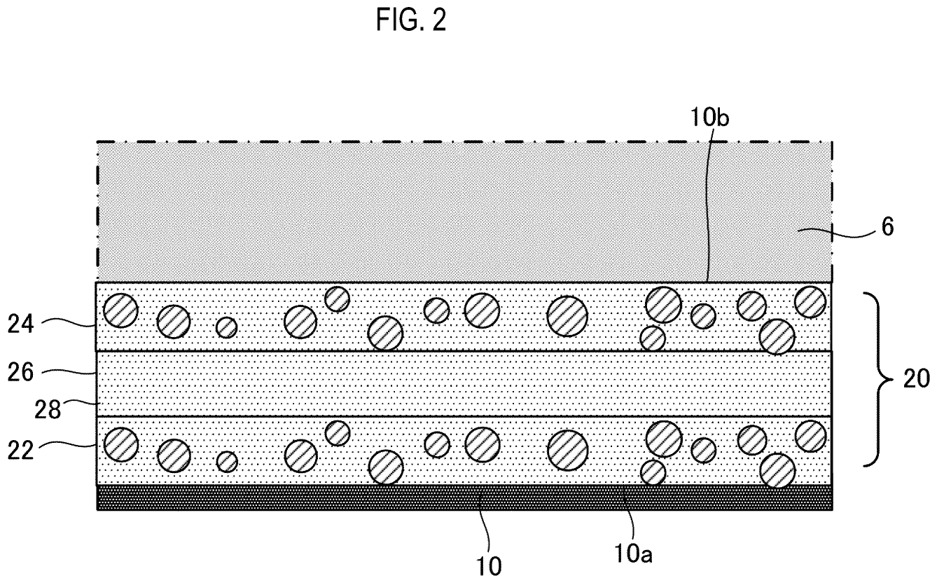

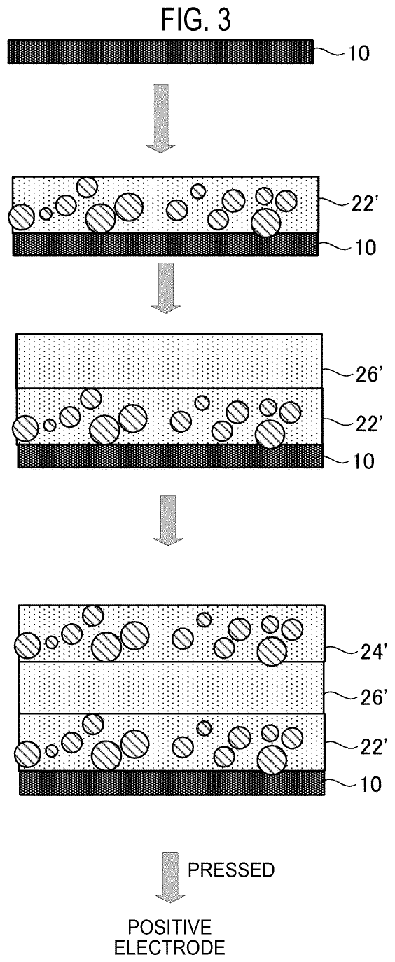

FIG. 2 schematically shows an example of the positive electrode mixture layer 20, and FIG. 3 schematically shows an example of a manufacturing step of the positive electrode 4. In FIGS. 2 and 3, in order to emphasize the distribution of the layered rock salt oxide in a first region 22, a second region 24, and a third region 26, the layered rock salt oxide is solely shown as the active material. In FIGS. 2 and 3, the layered rock salt oxide is indicated by a circle with a diagonal line drawn inside.

As shown in FIG. 2, the positive electrode mixture layer 20 includes a first region 22, a second region 24, and a third region 26. The first region 22 is a region that is proximate to a first surface 10a facing the current collector 10 in the thickness direction of the positive electrode mixture layer 20. That is, the first region 22 is a region closest to the current collector 10 in the positive electrode mixture layer 20. In addition, the second region 24 is a region that is proximate to a second surface 10b facing the separator 6 in the thickness direction, and is a region closest to the separator 6. The third region 26 is a region between the first region 22 and the second region 24.

In the positive electrode mixture layer 20, the concentration of the layered rock salt oxide in the first region 22 and the second region 24 is higher than that in the third region 26. By containing the layered rock salt oxide at a high concentration in the first region 22 and the second region 24, it is possible to contribute to excellent direct current internal resistance (DCIR) in the secondary battery 100 due to high electronic conductivity based on the layered rock salt oxide. In particular, containing the layered rock salt oxide at a high concentration in the second region 24 may contribute to a decrease in DCIR.

In addition, containing the layered rock salt oxide at a high concentration in the first region 22 may improve the peel strength between the positive electrode mixture layer 20 and the positive electrode current collector 10. For example, since the layered rock salt oxide tends to have a small surface area due to the shape thereof, the peel strength with the positive electrode current collector 10 tends to be easily ensured even with a small amount of binder.

The first region 22 and the second region 24 may contain the layered rock salt oxide at a higher concentration than the third region 26. Although not limited thereto, for example, the first region 22 and the second region 24 can each contain the layered rock salt oxide at a ratio of 5% by mass or more and 40% by mass or less with respect to the total mass of the layered rock salt oxide and the olivine compound. The ratio of the olivine compound is the remaining part, and is, for example, 60% by mass or more and 95% by mass or less. In addition, the ratio of the layered rock salt oxide is, for example, 8% by mass or more, 10% by mass or more, 12% by mass or more, 15% by mass or more, and 20% by mass or more, and is 35% by mass or less, 30% by mass or less, and 25% by mass or less. The range of the ratio of the layered rock salt oxide can be appropriately set, and is, for example, 8% by mass or more and 35% by mass or less, and is 10% by mass or more and 30% by mass or less. In the first region 22 and the second region 24, the concentration of the layered rock salt oxide may be the same or different.

The first region 22 and the second region 24 contain the layered rock salt oxide in the concentration range, and the third region 26 contains the layered rock salt oxide at a lower concentration. As a result, it is possible to efficiently contribute to a decrease in DCIR and an improvement in peel strength between the separator 6 and the positive electrode current collector 10.

The third region 26 may contain the layered rock salt oxide at a lower concentration than the first region 22 and the second region 24, and the concentration of the layered rock salt oxide is not particularly limited. For example, the concentration of the layered rock salt oxide is 20% by mass or less, 15% by mass or less, 10% by mass or less, 5% by mass or less, 3% by mass or less, 1% by mass or less, 0.5% by mass or less, 0.1% by mass or less, and 0.01% by mass or less with respect to the total mass of the layered rock salt oxide and the olivine compound. The olivine compound is the remaining part. Even in a case where the concentration of the layered rock salt oxide in the third region 26 is 0.01% by mass or less or the third region 26 does not contain the layered rock salt oxide, the DCIR can be decreased by the presence of the layered rock salt oxide in the first region 22 and the second region 24, and thus the amount of the layered rock salt oxide used can be reduced.

The third region 26 may include a fourth region 28 that solely contains the olivine compound without containing the layered rock salt oxide, or the entire third region 26 may be such a fourth region 28. In this manner, the amount of the layered rock salt oxide used can be reduced.

The concentration of the layered rock salt oxide in the positive electrode mixture layer 20 may change stepwise through the regions 22, 24, 26, 28 in the thickness direction, or may change gradually in a gradient manner.

In the entire positive electrode mixture layer 20, the positive electrode mixture layer 20 can contain the layered rock salt oxide at 5% by mass or more and 20% by mass or less and can contain the olivine compound at 80% by mass or more and 95% by mass or less with respect to the total mass of the layered rock salt oxide and the olivine compound. By having the predetermined distribution of the layered rock salt oxide, the positive electrode mixture layer 20 can obtain excellent DCIR and excellent integrity with the positive electrode current collector 10 in the secondary battery 100 while the content of the layered rock salt oxide in the entire positive electrode mixture layer 20 is set within the above-described range. The ratio of the layered rock salt oxide may be 7% by mass or more and 20% by mass or less.

The contents of the layered rock salt oxide and the olivine compound in the positive electrode mixture layer 20 are, for example, 85% by mass or more and 98% by mass or less, 90% by mass or more and 97% by mass or less, and 90% by mass or more and 95% by mass or less of the total amount of the positive electrode mixture used in the positive electrode mixture layer 20.

The distribution of the layered rock salt oxide or the olivine compound in the first region 22, the second region 24, and the third region 26 can be acquired, for example, by an energy dispersive X-ray fluorescence analysis device. In addition, the distribution can also be acquired by sampling from each of the regions 22, 24, 26 and measuring the concentration of the layered rock salt oxide or the olivine compound.

The thickness of each of the first region 22 and the second region 24 depends on the total thickness of the positive electrode mixture layer 20, but may be, for example, 1% or more and 40% or less of the total thickness. In addition, for example, the thickness is 2% or more, 3% or more, 4% or more, 5% or more, 6% or more, 7% or more, 8% or more, 9% or more, 10% or more, and 15% or more. In addition, the thickness is 35% or less, 30% or less, 25% or less, 20% or less, and 15% or less. The thickness of the first region 22 and the second region 24 can be appropriately set, and is, for example, 3% or more and 35% or less, and 5% or more and 30% or less. The thicknesses of the first region 22 and the second region 24 may be the same or different from each other.

For example, the thicknesses of the first region 22, the second region 24, and the third region 26 in the positive electrode mixture layer 20 are not particularly limited. The thickness of the first region 22 may be sufficient as long as the thickness is several m to several tens of m from the first surface 10a. In addition, the thickness of the second region 24 may be sufficient as long as the thickness is several m to several tens of m from the second surface 10b.

The thickness of the third region 26 is also not particularly limited. The remaining thickness of the regions 22, 24 that is effective in ensuring the contribution to the DCIR by the first region 22 and the second region 24 can be set as the thickness of the third region 26.

The thickness of each of the first region 22, the second region 24, the third region 26, and the like is acquired based on the distribution of the layered rock salt oxide in the energy dispersive X-ray fluorescence analysis device. In addition, the thickness of each of the first region 22, the second region 24, the third region 26, and the like can be acquired based on the interface or the like at the time when these regions 22 and the like are laminated while the cell 2 is manufactured.

The thickness of the positive electrode mixture layer 20 is not particularly limited, but is, for example, 50 μm or more and 200 μm or less, or 50 μm or more and 100 m or less.

The positive electrode mixture layer 20 contains a layered rock salt oxide and an olivine compound. In a case where a particle size D₅₀ of these satisfies the following relationship, it contributes to improving the discharge characteristics in the secondary battery 100 and the adhesiveness and the peel strength between the positive electrode mixture layer 20 and the positive electrode current collector 10.

That is, it may be preferable that the first particle size ratio R1 (d11/d12) is greater than the second particle size ratio R2 (d21/d22). The first particle size ratio R1 (d11/d12) is a ratio of D₅₀ (volume basis, the same applies hereinafter) (d11) of the layered rock salt oxide to D₅₀ (d12) of the olivine compound in the first region 22. The second particle size ratio R2 (d21/d22) is a ratio of D₅₀ (d21) of the layered rock salt oxide to D₅₀ (d22) of the olivine compound in the second region 24.

In this manner, in a case where a laminate including the current collector 10 and the separator 6 is pressed to the positive electrode mixture layer 20, the first region 22 close to the current collector 10 tends to be more easily compressed than the second region 24. This is because the particle size ratio R1 in the first region 22 is greater than the particle size ratio R2 in the second region 24. As a result, the first region 22 is crimped to the current collector 10, and the adhesiveness and the peel strength are improved. In addition, since the second region 24 close to the separator 6 is less likely to be compressed than the first region 22, the lithium ion diffusivity is improved in the vicinity of the second surface 10b of the second region 24, thereby contributing to excellent discharge characteristics.

The first particle size ratio R1 and the second particle size ratio R2 are not particularly limited, but for example, R1 is 10 or more and 20 or less, or 12 or more and 18 or less, and R2 is less than 10, 9 or less, 8 or less, or 7 or less.

The D₅₀ can be measured as a particle size corresponding to a cumulative 50% by volume from a smaller particle size (fine particle side) in a volume-based particle size distribution (cumulative distribution) based on a laser diffraction and scattering method.

### Layered Rock Salt Oxide

The layered rock salt oxide is not particularly limited, and a known layered rock salt oxide can be used. As the layered rock salt oxide, for example, one or two or more oxides selected from lithium-containing transition metal oxides represented by Formula (1) can be used. This kind of layered rock salt oxide may be a single crystal oxide or a polycrystalline oxide. This kind of layered rock salt oxide has excellent electronic conductivity.

LiNiₐCo_{b}Mn_{c}M¹_{w}O₂ Formula (1)

(In Formula (1), M¹ represents one or two or more elements selected from Mg, Ti, Nb, Fe, Cr, Si, Al, Ga, V, Zn, Cu, Sr, Mo, Zr, Sn, Ta, W, La, Ce, Pb, Bi, and Ge. a, b, c, and w represent numbers satisfying 0.25≤a<0.80, 0<b≤0.74, 0<c≤0.74, 0<w≤0.34, and 3a+3b+3c+(valence of M¹)×w=3.)

This oxide is one of so-called Li—Ni—Co—Mn oxides (NCM-based oxides or NCM).

In the NCM-based oxide, it is known that Ni, Co, and Mn have excellent electronic conductivity and contribute to the battery capacity and the output characteristics. In addition, from the viewpoint of the cycle characteristics, it may be preferable that a part of such a transition element is substituted with another metal element M¹.

a that is a molar ratio of Ni in the oxide is 0.25≤a<0.80. In a case where the molar ratio of Ni is 0.80 or more, the deterioration of the NCM-based oxide itself is also large, and the effect of improving the cycle characteristics is small. In consideration of the cycle characteristics (capacity retention rate) and the like, for example, a is 0.30 or more, 0.40 or more, 0.50 or more, 0.55 or more, 0.60 or more, or 0.70 or more. In addition, for example, a is 0.78 or less, 0.74 or less, 0.70 or less, 0.60 or less, or 0.64 or less. The range of a can be set by selecting these lower limits and upper limits, and for example, can be set to 0.40 or more and 0.74 or less, 0.50 or more and 0.74 or less, 0.55 or more and 0.74 or less, 0.60 or more and 0.70 or less, or the like. In a case where the molar ratio in the present specification is indicated in percentage, the molar ratio is mol %.

b that is a molar ratio of Co in the NCM-based oxide is 0<b≤0.74. For example, b is 0.10 or more, 0.15 or more, or 0.20 or more, and for example, b is 0.70 or less, 0.50 or less, 0.40 or less, 0.34 or less, 0.30 or less, 0.24 or less, or 0.20 or less. The range of b can be set by selecting these lower limits and upper limits, and for example, can be set to 0.10 or more and 0.40 or less, 0.10 or more and 0.30 or less, 0.10 or more and 0.24 or less, or the like.

c that is a molar ratio of Mn in the NCM-based oxide is 0<c≤0.74. For example, c is 0.10 or more, 0.15 or more, and for example, c is 0.70 or less, 0.50 or less, 0.34 or less, 0.30 or less, 0.24 or less, 0.20 or less, or 0.15 or less. The range of c can be set by selecting these lower limits and upper limits, and for example, can be set to 0.10 or more and 0.34 or less, 0.15 or more and 0.34 or less, or the like.

The NCM-based oxide is not particularly limited, but from the viewpoint of the cycle characteristics and the like, examples thereof include LiNi_{0.70}Co_{0.10}Mn_{0.20}O₂, LiNi_{0.60}Co_{0.20}Mn_{0.20}O₂, LiNi_{0.50}Co_{0.30}Mn_{0.20}O₂, LiNi_{0.33}Co_{0.31}Mn_{0.33}Mg_{0.03}O₂, and LiNi_{0.33}Co_{0.31}Mn_{0.33}Zn_{0.03}O₂. Among these, for example, LiNi_{0.70}Co_{0.10}Mn_{0.20}O₂, LiNi_{0.60}Co_{0.20}Mn_{0.20}O₂, and LiNi_{0.50}Co_{0.30}Mn_{0.20}O₂ may be preferable. In addition, for example, an NCM-based oxide containing a composition of LiNi_{0.70}Co_{0.10}Mn_{0.20}O₂ and LiNi_{0.60}Co_{0.20}Mn_{0.20}O₂ may be preferable from the viewpoint of the cycle characteristics (capacity retention rate) at a high temperature.

The NCM-based oxide is a single crystal, and thus it can contribute to the cycle characteristics of the secondary battery. This is because, in a case where the NCM-based oxide is a polycrystal, cracks are likely to occur due to particle cracking by charging and discharging. The crystallinity of the single crystal can be confirmed by an X-ray diffraction spectrum and an optical microscope.

The NCM-based oxide is generally spherical or irregularly shaped particles, depending on a manufacturing method and the like. An average particle size (D₅₀, primary particle size) of the NCM-based oxide is not particularly limited. In the positive electrode mixture layer 20, the average particle size is appropriately set within a range in which dispersion is possible to obtain the intended characteristics. For example, the average particle size is 50 nm or more and 20 μm or less, 1 μm or more and 20 μm or less, 3 μm or more and 20 μm or less, or 3 μm or more and 10 μm or less. The average particle size D₅₀ can be measured as a particle size corresponding to a cumulative 50% by volume from a smaller particle size (fine particle side) in a volume-based particle size distribution (cumulative distribution) based on a laser diffraction and scattering method.

As the layered rock salt oxide, in addition to the NCM-based oxide, so-called NCA-based oxides represented by Formula (3), or one or two or more of other known lithium-containing transition metal oxides can be appropriately selected and used or used in combination.

LiNi_{d}CoₑAl_{f}M³ₓO₂ Formula (3)

(In Formula (3), M³ represents one or two or more elements selected from Mg, Ti, Nb, Fe, Cr, Si, Ga, V, Zn, Cu, Sr, Mo, Zr, Sn, Ta, W, La, Ce, Pb, Bi, and Ge. d, e, f, and x represent numbers satisfying 0.4≤d<1, 0<e≤0.5, 0<f≤0.3, 0≤x≤0.3, and 3d+3e+3f+(valence of M³)×x=3.)

A content of the NCA-based oxide in the layered rock salt oxide is not particularly limited. From the viewpoint of the cycle characteristics and the like, for example, the content can be set to 70% by mass or more and 100% by mass or less, 80% by mass or more and 100% by mass or less, 90% by mass or more and 100% by mass or less, 95% by mass or more and 100% by mass or less, 99% by mass or more and 100% by mass or less, 100% by mass, or the like.

### Olivine Compound

As the olivine compound, various known olivine compounds can be used without particular limitation. As the olivine compound, for example, one or two or more compounds selected from compounds represented by Formula (2) can be used. This kind of lithium manganese iron phosphate has excellent structural stability by adopting an olivine type, and thus it can contribute to safety. In addition, it may contribute to an improvement in energy density per unit area.

Li_{g}MnₕFeᵢM²_{y}PO₄ Formula (2)

(In Formula (2), M² represents one or two or more elements selected from Mg, Al, Ti, Cu, Zn, Nb, Co, Ni, Ca, Sr, Y, Zr, Mo, Ba, Pb, Bi, La, Ce, Nd, and Gd. g, h, i, and y represent numbers satisfying 0<g≤1.2, O<h≤1.2, 0≤i≤1.2, where h+i is not 0, 0≤y≤0.30, and g+(valence of Mn)×h+(valence of Fe)×i+(valence of M²)×y=3.)

Examples of the olivine compound represented by Formula (2) include LMFP, LMP, and LFP. It is preferably LMFP. In Formula (2), from the viewpoint of increasing the energy density per unit volume, M² is preferably Mg, Al, Ti, Zn, Nb, Co, Zr, or Gd.

In addition, g that is a molar ratio of Li in Formula (2) is more than 0 and 1.2 or less, but for example, is 0.60 or more and 1.20 or less, 0.65 or more and 1.15 or less, or 0.70 or more and 1.10 or less.

h that is a molar ratio of Mn in Formula (2) is more than 0 and 1.2 or less. In a case of LMFP, from the viewpoint of reducing the elution of Mn, for example, h is 0.15 or more, 0.20 or more, 0.25 or more, 0.30 or more, 0.35 or more, or 0.40 or more, and for example, h is 0.84 or less, 0.80 or less, 0.74 or less, or 0.70 or less. The range of h is, for example, 0.20 or more and 0.80 or less. h is 0.30 or more and 0.80 or less, 0.40 or more and 0.80 or less, 0.35 or more and 0.74 or less, 0.40 or more and 0.70 or less, or 0.50 or more and 0.70 or less.

i that is a molar ratio of Fe in Formula (2) is 0 or more and 1.2 or less. In a case of LMFP, for example, i is 0.30 or more and 0.60 or less, and for example, i is 0.30 or more and 0.50 or less.

y that is a molar ratio of M² in Formula (2) is 0 or more and 0.3 or less, but for example, is 0 or more and 0.20 or less, 0 or more and 0.15 or less, or 0 or more and 0.10 or less.

The olivine compound is not particularly limited, but examples thereof include LiMnPO₄, LiFePO₄, LiMn_{0.20}Fe_{0.80}PO₄, LiMn_{0.30}Fe_{0.70}PO₄, LiMn_{0.40}Fe_{0.60}PO₄, LiMn_{0.50}Fe_{0.50}PO₄, LiMn_{0.60}Fe_{0.40}PO₄, and Li_{1.2}Mn_{0.53}Fe_{0.37}PO₄. Among these, LiMn_{0.60}Fe_{0.40}PO₄ may be preferable from the viewpoint of cost and the like.

The olivine compound such as LMFP is generally spherical or irregularly shaped particles, depending on a manufacturing method and the like. An average particle size (primary particle size) and a particle size distribution range of the olivine compound such as LMFP are not particularly limited. In the positive electrode mixture layer 20, the average particle size is appropriately set within a range in which dispersion is possible to obtain the intended characteristics. The average particle size of the olivine compound such as LMFP is, for example, 1 nm or more and 10 μm or less, 1 nm or more and 2 μm or less, 1 nm or more and 1 μm or less, or 1 nm or more and 0.5 μm or less. By reducing the primary particle size, the lithium ion diffusivity in the particles can be improved. In addition, the olivine compound such as LMFP may be a granulated body in which primary particles are granulated. In this case, the granulated body may be preferably granulated from primary particles having a particle size of 100 nm or less. The average particle size of the olivine compound such as LMFP can be measured as D₅₀ in a volume-based particle size distribution (cumulative distribution) based on a laser diffraction and scattering method, as in the single crystal oxide described above.

The positive electrode mixture layer 20 can appropriately contain a binder, a conductive additive, and other additives in addition to the positive electrode active material. Examples of the binder include one or two or more of a fluororesin such as polytetrafluoroethylene (PTFE) or polyvinylidene fluoride (PVDF), polyacrylonitrile (PAN), polyimide, an acrylic resin, and a polyolefin. In addition, examples of the conductive additive include one or two or more of carbon materials such as carbon black, acetylene black, Ketjen black, graphite, and carbon nanotubes.

### Manufacturing Method of Positive Electrode Mixture Layer and Positive Electrode

The positive electrode mixture layer 20 is prepared by mixing the positive electrode active material, the binder, the conductive additive, and a needed solvent. For example, as shown in FIG. 3, a mixture slurry having a composition corresponding to the first region 22 is supplied to the current collector 10 by a known method to form a first region precursor layer 22′. Next, a mixture slurry having a composition corresponding to the third region 26 is supplied to the first region precursor layer 22′ to laminate a third region precursor layer 26′. Further, a mixture slurry having a composition corresponding to the second region 24 is supplied to the third region precursor layer 26′ to form a second region precursor layer 24′. The laminate including the first region precursor layer 22′, the third region precursor layer 26′, and the second region precursor layer 24′ in this order on the current collector 10 is dried, pressed, and the like to manufacture the positive electrode mixture layer 20 and the positive electrode 4 including the current collector 10 in the positive electrode mixture layer 20.

Further, by integrating the separator 6 and the negative electrode 8 including the negative electrode mixture layer 30 and the negative electrode current collector 12 into the positive electrode 4, the cell 2 can be obtained.

### Secondary Battery

The secondary battery 100 according to the present disclosure is configured by laminating a plurality of cells 2. The secondary battery 100 includes the positive electrode 4, the negative electrode 8, an electrolyte (liquid, gel, or solid), and the separator 6. The negative electrode 8, the electrolyte, and the separator 6 are not particularly limited, and known materials and configurations can be appropriately applied. For example, as the negative electrode 8, a lithium metal and a carbon material such as graphite, a silicon-based material (Si, SiOx), lithium titanate, or amorphous carbon can be used. The electrolyte solution is, for example, a solution obtained by dissolving a supporting salt in an organic solvent. The organic solvent is not particularly limited as long as it is an organic solvent usually used in an electrolytic solution of a lithium-ion secondary battery. For example, carbonates, halogenated hydrocarbons, ethers, ketones, nitriles, lactones, oxolane compounds, and the like can be used. In addition, the type of the supporting salt is not particularly limited, and a known organic salt such as LiPF₆ or LiBF₄ or a derivative thereof can be used. As the separator 6, for example, a porous synthetic resin film, particularly a porous film of a polyolefin-based polymer (polyethylene (PE) or polypropylene (PP)), can be used. In addition, the solid electrolyte may be any solid electrolyte that electrically insulates the positive electrode and the negative electrode and exhibits high lithium ion conductivity, and a known solid electrolyte can be appropriately used.

The shape of the secondary battery 100 having the above-described configuration is not particularly limited, and may be various shapes such as a coin type, a cylindrical type, and a prismatic type, or may be an irregular shape sealed in a laminate exterior body.

Hereinafter, embodiments for specifically describing the disclosure of the present specification will be described. Therefore, the disclosure of the present specification is not limited to the following embodiments.

### Embodiment 1

In the present embodiment, a cell for evaluation was produced, and the 3 C discharge capacity retention rate and the peel strength were evaluated. Table 1 shows the configuration of the produced positive electrode.

### (1) Production of Positive Electrode

The positive electrode of Embodiment 1 was produced as follows. That is, a slurry for a first region (current collector side) was prepared using LMFP (Mn 60 mol %, Fe 40 mol %) (D₅₀ 0.5 μm) that is an olivine compound and NCM (Ni 60 mol %, Co 20 mol %, Mn 20 mol %) (D₅₀ 3.5 μm) that is a polycrystalline layered rock salt oxide as the positive electrode active material. The first region (current collector side) was configured with LMFP:NCM:carbon nanotube (CNT):polyvinylidene fluoride (PVDF)=66.15:28.35:1.5:4.0 (% by mass). In this slurry, 30% by mass of NCM was contained in the total mass of NCM and LMFP as the active material. The slurry was applied onto an Al foil having a thickness of 30 μm using a doctor blade such that the coating weight was 8.7 mg/cm².

Next, a slurry for a third region (central portion) configured with LMFP:CNT:PVDF=94.5:1.5:4.0 (% by mass) was prepared. The slurry solely contained LMFP as the active material and did not contain NCM. The slurry was applied onto the coating layer of the slurry for the first region using a doctor blade such that the coating weight was 8.7 mg/cm².

Further, a slurry for a second region (separator side) configured with LMFP:NCM:carbon nanotube (CNT):polyvinylidene fluoride (PVDF)=66.15:28.35:1.5:4.0 (% by mass) was prepared. In this slurry, 30% by mass of NCM was contained in the total mass of NCM and LMFP as the active material. The slurry was applied onto the coating layer of the slurry for the third region using a doctor blade such that the coating weight was 8.7 mg/cm².

The laminate thus obtained was dried at 100° C. for 10 minutes, and pressed such that the density was 2.6 g/cc, thereby producing a positive electrode of Embodiment 1.

The positive electrode of Embodiment 2 was produced in the same manner as in Embodiment 1, except that the compositions of LMFP and NCM in the first region and the second region were as shown in Table 1. In addition, the positive electrode of Embodiment 3 was produced in the same manner as in Embodiment 1, except that NCM having D₅₀ of 8 μm was used instead of the NCM used in Embodiment 1, and the compositions of LMFP and NCM in the first region to the second region were as shown in Table 1. The NCM was NCM used in the slurry for the first region (current collector side).

The positive electrodes of Comparative Examples 1, 2 were produced in the same manner as in Embodiment 1, except that the compositions of LMFP and NCM in the first region to the third region were as shown in Table 1.

### (2) Production of Negative Electrode

Artificial graphite (average particle size: 22 μm) was used as the negative electrode active material, and a slurry of active material:SBR:CMC=96:3:1 (% by mass) was produced and applied onto a Cu foil having a thickness of 15 μm using a doctor blade such that the single-sided coating weight was 13 mg/cm² (the ratio of the positive electrode capacity to the negative electrode capacity was 1.1). Thereafter, it was dried at 100° C. for 10 minutes, and pressed such that the density was 1.25 g/cc, thereby producing a negative electrode.

### (3) Production of Cell

The positive electrode of each of Embodiments and Comparative Examples, the separator (a three-layer laminate of PP/PE/PP, 16 μm), and the negative electrode were laminated to produce a laminate cell. As the electrolytic solution, 1.1 M LiPF₆ in EC:DMC:EMC=30:40:30 (% by volume) was used. The cell was subjected to a confinement pressure of 500 kPa.

### (4) Direct Current Internal Resistance (DCIR)

For Embodiment 1 and Comparative Examples 1, 2, the direct current internal resistance was measured at 25° C., an SOC of 60%, and 10 seconds according to a general method. The results are shown in Table 1.

### (5) Activation and Capacity Retention Rate Evaluation at 25° C.

The initial charging current was set to a constant current-constant voltage method, and the battery was charged at a constant current of a current value of 0.1 C until 4.30 V, and was charged at a constant voltage until the time of the constant voltage charging was 3 hours, and was discharged at a current value of 0.1 C until 3.0 V by a constant current method, thereby activating the battery. After the activation treatment, the battery was charged at a constant current of a current value of 0.1 C until 4.30 V by a constant current-constant voltage method in an environment of 25° C., and was discharged at a current value of 0.1 C until 3.0 V by a constant current method, thereby calculating an initial discharge capacity.

In the discharge rate test, the battery was charged at a constant current of a current value of 0.1 C until 4.30 V by a constant current-constant voltage method in an environment of 25° C., and was discharged at a current value of 3 C until 3.0 V by a constant current method. A 3 C discharge capacity retention rate with respect to the 0.1 C discharge capacity was calculated. The results are shown in Table 1.

### (6) Peel Strength

The peel test was performed in an environment of 90° C., and the peel strength was measured. The results are shown in Table 1.

TABLE 1

| | Current collector side (first region) | | | | Central portion (third region) | | | |
|---|---|---|---|---|---|---|---|---|
| | Olivine compound | | Layered rock salt | | Olivine compound | | Layered rock salt | |
| | LMFP | | oxide NCM | | LMFP | | oxide NCM | |
| | D50 | Content | D50 | Content | D50 | Content | D50 | Content |
| Type | μm | % by mass | μm | % by mass | μm | % by mass | μm | % by mass |
| Embodiment 1 | 0.5 | 70 | 3.5 | 30 | 0.5 | 100 | — | — |
| Embodiment 2 | 0.5 | 90 | 3.5 | 10 | 0.5 | 100 | — | — |
| Embodiment 3 | 0.5 | 90 | 8.0 | 10 | 0.5 | 100 | — | — |
| Comparative | 0.5 | 80 | 3.5 | 20 | 0.5 | 80 | 3.5 | 20 |
| Example 1 | | | | | | | | |
| Comparative | 0.5 | 100 | — | — | 0.5 | 100 | — | — |
| Example 2 | | | | | | | | |

| | Separator side (second region) | | | | | | |
|---|---|---|---|---|---|---|---|
| | Olivine compound | | Layered rock salt | | | | |
| | LMFP | | oxide NCM | | | | 3 C |
| | D50 | Content | D50 | Content | DCIR | Peel | discharge |
| Type | μm | % by mass | μm | % by mass | Ω | strength | rate % |
| Embodiment 1 | 0.5 | 70 | 3.5 | 30 | 1.2 | 0.30 | 70.1 |
| Embodiment 2 | 0.5 | 90 | 3.5 | 10 | — | 0.29 | 70.5 |
| Embodiment 3 | 0.5 | 90 | 3.5 | 10 | — | 0.35 | 72.5 |
| Comparative | 0.5 | 80 | 3.5 | 20 | 1.6 | 0.15 | 67.8 |
| Example 1 | | | | | | | |
| Comparative | 0.5 | 80 | 3.5 | 20 | 1.1 | 0.08 | 63.1 |
| Example 2 | | | | | | | |

As shown in Table 1, it was found that the direct current internal resistance of Embodiment 1 was lower than that of Comparative Example 1 (uniform dispersion), and the bias of NCM contributed to the direct current internal resistance. In addition, in Embodiments 1 to 3, the 3 C discharge rate was more than 70%, whereas in Comparative Examples 1, 2, the 3 C discharge rate was in the 60% range. Embodiments 1 to 3 had more excellent peel strength and 3 C discharge rate than Comparative Example 1 in which LMFP and NCM were simply mixed and laminated. As a result, it was found that the bias of NCM at a high concentration on the current collector side and the separator side contributed to the peel strength and the 3 C discharge performance. In a comparison between Embodiments 1 to 3 and Comparative Example 2 in which NCM was not included on the current collector side, it was found that the bias of NCM at a high concentration on the current collector side greatly contributed to the peel strength and the 3 C discharge performance.

In addition, from Embodiments 1 to 3, it was found that the peel strength and the 3 C discharge performance were reliably improved in a range of a concentration of NCM of 10% by mass or more and 30% by mass or less on both the current collector side and the separator side. Further, from a comparison between Embodiments 1, 2 and Embodiment 3, it was found that a ratio of D₅₀ of NCM/D₅₀ of LMFP on the current collector side (8/0.5=16) was greater than that on the separator side (3.5/0.5=7), thereby contributing to the improvement in the peel strength. It was considered that this is because, since the region was easily compressed during pressing due to the great D₅₀ of NCM/D₅₀ of LMFP on the current collector side, the peel strength was improved. On the other hand, it was considered that, since the D₅₀ of NCM/D₅₀ of LMFP on the separator side was small, the region was not easily compressed even during pressing, and the lithium ion diffusivity was improved, thereby contributing to the improvement in the 3 C discharge rate.

Although specific examples of the technology disclosed in the present specification have been described in detail above, these examples are merely illustrative and do not limit the scope of the claims. The technology described in the claims includes various modifications and changes of the specific examples exemplified above. The technical elements described in the present specification or the drawings exhibit technical usefulness alone or in various combinations, and are not limited to the combinations described in the claims at the time when the present specification is filed. The technology exemplified in the present specification or the drawings can achieve a plurality of objectives at the same time, and achieving one of the objectives has technical usefulness.

What is claimed is:

1. A positive electrode comprising a positive electrode mixture layer containing a layered rock salt oxide and an olivine compound as a positive electrode active material, wherein:
the positive electrode mixture layer includes a first region proximate to a first surface facing a current collector in a thickness direction of the positive electrode mixture layer, a second region proximate to a second surface facing a separator in the thickness direction, and a third region that is a region between the first region and the second region in the thickness direction; and
the first region and the second region contain the layered rock salt oxide at a higher concentration than the third region.

2. The positive electrode according to claim 1, wherein a first particle size ratio that is a ratio of D₅₀ (volume basis) of the layered rock salt oxide to D₅₀ (volume basis) of the olivine compound in the first region is greater than a second particle size ratio that is a ratio of D₅₀ (volume basis) of the layered rock salt oxide to D₅₀ (volume basis) of the olivine compound in the second region.

3. The positive electrode according to claim 1, wherein the first region is a region of 10% or less of a thickness of the positive electrode mixture layer from the first surface, and the second region is a region of 10% or less of a thickness of the positive electrode mixture layer from the second surface.

4. The positive electrode according to claim 1, wherein the third region includes a fourth region containing solely the olivine compound as the positive electrode active material.

5. A lithium-ion secondary battery comprising:
the positive electrode according to claim 1, the positive electrode being provided for the lithium-ion secondary battery;
a negative electrode; and
the separator.
